(19) United States
(12) Patent Application Publication
(10) Pub. No.: US 2024/0119322 A1
(43) Pub. Date: Apr. 11, 2024

(54) Probabilistic Model of Decision-Making

(71) Applicants: Michael Louis Oristaglio, Newtown, CT (US); Thorkild Hansen, Boxford, MA (US)

(72) Inventors: Michael Louis Oristaglio, Newtown, CT (US); Thorkild Hansen, Boxford, MA (US)

(21) Appl. No.: 17/936,718

(22) Filed: Sep. 29, 2022

(51) Int. Cl. G06N 7/00

(52) U.S. Cl. CPC G06N 7/005

(57) ABSTRACT

An algorithmic model of decision-making, defined as the automatic selection of one choice from a set of possible choices, is disclosed and described. The model is probabilistic in that it uses random selection to complete the act of decision-making but also incorporates non-random processes—involving algorithms of feedback, analogy, and prediction—which can modify selection probabilities in random decisions as the model evolves in time. These modifying processes are assumed to act between decisions in a precise way that is specified by algorithms comprising an embodiment of the model. The combination of random and deterministic processes produces a model with a kind of “freedom of choice” that lies somewhere between fully random and fully deterministic, as conditioned by the model's history.

### TECHNICAL FIELD

This disclosure relates to algorithms embodied in software for making decisions (“decision-making”), which is defined here as the selection of one choice from a set of possible choices. More particularly, the disclosure relates to an algorithmic method that uses random selection to make choices, but also incorporates non-random processes involving algorithms of feedback, analogy, and prediction to modify selection probabilities of the random step and thereby improve the odds of making a good choice, while allowing the algorithm some freedom of choice—a characteristic of human decisions.

### BACKGROUND

Software embodying algorithms for automated decision-making—for example, by automatically selecting one choice from a collection of possible choices—is now a standard tool in fields as diverse as diagnostic medicine, image analysis and classification, targeted advertising (suggestion of products and services), automated financial investment, and natural language processing, including machine translation. Many varieties of algorithms are used in these fields, including expert systems, Bayesian networks, and neural networks trained by machine learning. Such systems are often described by the general term “artificial intelligence” (AI).

### BRIEF SUMMARY

The model of decision-making developed here starts with a finite collection or set of possible choices, designated by

C={c₁, c₂, . . . , c_{N}_{ᵥ}}={cⱼ, j=1, . . . , N_{c}}.

Examples of sets of choices are:
Binary conditions: {disease is present in the sample, sample is normal},
Concrete objects: {white wine, red wine, beer},
Abstract objects (ticker symbols): {APPL, FB, GOOGL, TNX, TSLA, OIL, ARE}
Actions: {go to a movie, watch TV, go to bed},
Combinations of objects and actions: {take the red convertible to the beach, take the sedan to the grocery store, take the truck to the quarry},
   Combinations can be considered as consecutive simple choices—for example, an object followed by an action, or vice versa—provided that the sequence fully captures the possible combinations. In the model disclosed here, selection of a particular choice from a candidate set is done randomly—for example, by software generating a random integer and selecting the correspondingly labelled choice. In the random selection, choices can have different probabilities of selection. (A simple example is the roll of a pair of fair dice where the different outcomes 2 to 12 are not equally probable.) In the model disclosed here, the probabilities of choices are allowed to vary in time and are updated after each decision by processes involving direct feedback, analogy, and prediction. All methods of modifying the probabilities of selection must be specified in algorithms that can be computed explicitly given certain inputs. The final selection step, however, remains random, giving the model a freedom of choice that lies somewhere between purely random and purely deterministic, as conditioned by the model's history.

### BRIEF DESCRIPTION OF THE DRAWINGS

For a more complete understanding of the present disclosure, reference is now made to the following description taken in conjunction with the accompanying drawings.

FIG. 1 shows timelines of decision-making involving two sets of choices: C is the primary set of candidate choices; B is an auxiliary set of analogous choices. Decisions take place at discrete times tₖ marked by circles in the figure. A decision is the selection of a specific choice from a set of candidate choices at a given point in time. For example, selection of c₃ from set C at time t₁ is designated by c₃(1). Selections are made randomly by an algorithm that generates a random number between 1 and N_{c}, the number of choices in the candidate set. The appeal of each choice, which is designated by placing a bar over the choice, determines its probability of selection and is updated just before a decision is made. For example, c̅₃(1) is the appeal of choice 3 at decision time t₁. Updates to the appeal of choices relies on evaluating (or predicting) the “worth” of a selection at some time after the selection is made. For example, c₃*(1,2) is the worth of choice 3 at time t₂ after its selection at time t₁. The auxiliary set of choices B and its timeline are used when the concept of analogy between choices is used to update the appeal of choices in the primary set C.

FIG. 2 shows examples of functions of the resemblance between choices, sets of choices, and system states, which can be used in algorithms for updating the appeal of choices. The dashed curve is a linear function whose value rises from 0 to 1, proportionally to the resemblance which lies in the interval [0, 1]. The other curves labelled α={½,1,2,4} are warped versions of the logistic function whose independent variable, which normally runs from −∞ to +∞, is mapped to the interval [0, 1] (see paragraph [033]).

### DETAILED DESCRIPTION

In one simple embodiment of the model, consider a series of decisions at consecutive discrete times, tₖ, k=1, 2, . . . . Each decision is a selection from a set whose members (“candidate choices”) do not change over time,

C={c₁, c₂, . . . , c_{N}_{_{c}}}{cⱼ, j=1, . . . , N_{c}}, ∀tₖ.

Here, the mathematical symbol ∀ has its usual meaning: ∀tₖ→“For all tₖ”. To incorporate indecision, the first member of each set can correspond to “no choice”.

Associated with each choice in the candidate set is a non-negative number called the choice's “appeal,” which is designated by a bar over the choice and is allowed to be a function of (discrete) time, that is,

Appeal(cⱼ)∝c̅ⱼ(tₖ)=c̅ⱼ(k)≥0.

The appeal of all choices could, in the absence of prior information, be initialized to a common value, for example, c̅ⱼ(0)=1,∀j.

The appeals of choices in the candidate set at time t k determine their probabilities of selection by the formula

$${P}_{j} ( k ) = \frac{{\overline{c}}_{j} ( k )}{{\sum }_{i} {\overline{c}}_{i} ( k )} , j = 1 , ... , {N}_{c} . \qquad ( E1 )$$

The denominator ensures that the probability of each choice lies between 0 and 1 and that the sum of probabilities adds to 1. In the case where the appeals of all choices are equal, their probabilities of selection are also equal, Pⱼ=N_{c}⁻¹. In the model disclosed here, the appeals of choices and their corresponding probabilities from formula (E1) can change from decision to decision.

Associated with the selection of a particular choice at a given decision point is a real number (positive or negative) called its “worth.” This value is denoted by c*ₙ(k), which stands for “the present worth of choice cₙ given its selection at time tₖ.” For example, c*₃(1) is the present worth of having made choice 3 from set C when a decision was made at time t₁. For clarity, it will usually be convenient to specify precisely when the worth of a particular selection is being evaluated, which will be designated by a second argument in parenthesis, c*ₙ(k, k′). For example, c*₃(1,2) stands for “the worth at time t₂ of having selected choice c₃ at time t₁.”

A simple example may help to clarify these ideas and the notation. If the candidate choices are stocks to add to an investment portfolio, then the worth at time t₂ of having chosen stock number 3 (that is, c₃) at time t₁ could be given by the financial quantity called the stock's total return over the period from t₁ to t₂,

$${c}_{3}^{*} ( 1 , 2 ) = \frac{Price ( {c}_{3} , {t}_{2} )}{Price ( {c}_{3} , {t}_{1} )} .$$

Or, in general,

$${c}_{3}^{*} ( k , {k}^{′} ) = \frac{Price ( {c}_{3} , {t}_{{k}^{′}} )}{Price ( {c}_{3} , {t}_{k} )} .$$

Alternatively, the worth could be the gain in the price,

c*ₙ(k,k′)=Price(cₙ,tₖ′)−Price(cₙ,tₖ).

In this notation, c*ₙ(0,0) designates an initial worth which can be assigned to all cₙ to start the model.

Part of a full specification of an embodiment of the model disclosed here is a method for determining the worth of selections at specified points in time.

UPDATING BY DIRECT FEEDBACK. In a simple embodiment of the model, let the appeals of all choices are initialized at starting time t₀ and, in the absence of further information, remain unchanged until time t₁, when the first random selection is made using the probabilities given by formula (E1). Also let choices be given an initial or reference worth, which in the absence of prior information can be the same value for all choices. Let the first decision at t₁ select choice cₙ, and let its worth c*ₙ(1,⋅) at any time going forward be determined by a specified algorithm.

Before the next decision is made at time t₂, the model in this simple embodiment updates the appeal of choice cₙ with an algorithm represented by the formula,

c̅ₙ(2)=F_{D}(n,c*ₙ(1,2), a₁, a₂, . . . , a_{L}). (E2)

### Here,

F_{D} is a function of its arguments that must be fully specified as a computable algorithm.
n, the first explicit variable of F_{D}, designates the specific choice made (the updating algorithm may depend on the choice that was made).
αₗ, l=1, . . . , L, are a finite set of parameters which are part of the specification of the function F_{D}. These parameters can be determined within the model by a specified algorithm.
   In what follows, an ellipsis will stand for all parameters (in addition to explicitly listed variables) that enter the specification of an update function; thus, writing for formula (E2),

c̅ₙ(2)=F_{D}(n,c*ₙ(1,2), . . . ).

In this simple embodiment of the model, the appeal of all other candidate choices, aside from the one selected, can retain their values at time t₂; that is,

c̅ⱼ(2)=c̅ⱼ(1), ∀j≠n.

Notice, however, that changing the appeal of any one choice in formula (E1) changes the probabilities of all candidate choices.

An example of an update function F D for direct feedback is the following linear function which changes a choice's appeal by an amount proportional to its present worth,

ĉₙ(2)=max(0,α₁+α₂·(c*(1,2)−α₃)).

Here (α₁, α₂, α₃) are parameters determining the linear model. For example, α₁ could be set as the initial appeal of choice cₙ, α₁=ĉₙ(0), and α₃ could be set as its initial worth, α₃=c*ₙ(0,0). Then, the change in appeal of c n (after its selection) would be proportional to the (absolute) change in its worth—unless the appeal would become negative in which case the max(a, b) function, which returns the larger of its two arguments, ensures that a choice's appeal (and its corresponding probability) is never negative.

Formula (E2) can be rewritten as a general formula for updating the appeal of choices by direct feedback before a decision is made at an arbitrary time t k,

c̅ₙ(k)=F_{D}(n,c*ₙ(k−1, k), α₁(k), α₂(k), . . . , α_{L}(k)). (E3)

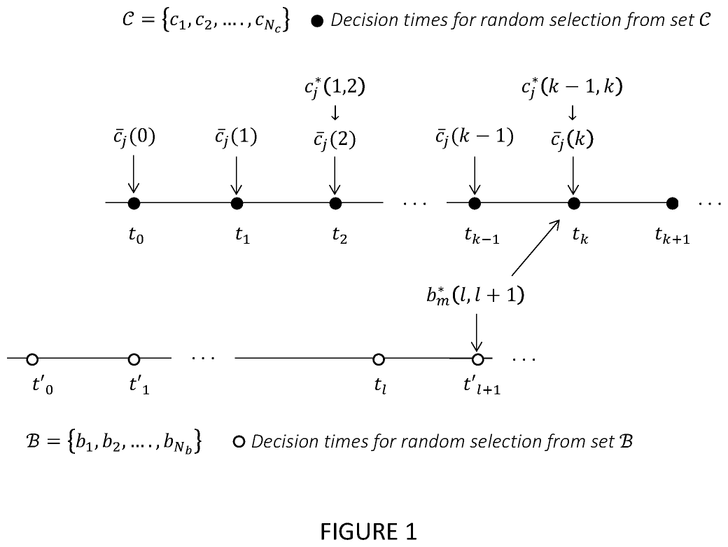

In this general form, the parameters of F_{D} can be varied in time by an algorithm specified in an embodiment. FIG. 1 shows the general timeline relating choices, decisions, appeals, and worths. The primary timeline (dark circles) involves choices updated by observation and evaluation of results of selections made from the candidate set C. The secondary timeline (open circles) involves observation of selections from an analogous set B, which can be used to influence decisions in the primary timeline by analogy, to be discussed next.

UPDATING BY ANALOGY. This section describes an indirect way of updating appeals that relies on analogy with choices made in the past. Consider two sets of choices,

C={c₁, c₂, . . . , c_{N}_{_{c}}}, B={b₁, b₂, . . . , b_{N}_{_{b}}},

which are quantitatively similar in a way to be specified by an algorithm. There are two similarities or “resemblances” to consider. First is the resemblance between two specific choices, one from each set, for example, cₙ and bₘ. Second is the overall resemblance of the two sets of choices, C and B. Use the following notation to stand for a function or algorithm that computes these resemblances,

r(cₙ,bₘ)=r(bₘ,cₙ)∝cₙ∘bₘ→[0,1], R(C,B)=R(B,C)∝C:B→[0,1].

As indicated, both functions yield numbers from 0 (“no resemblance”) to 1 (“identical”). The final paragraphs of this DETAILED DESCRIPTION provide examples of computable resemblances when candidate choices can be represented by an array of numbers, as, for example, with digital images.

Let all choices in set C be initialized with starting appeals and worths but not yet subject to a first decision at time t₁. Assume, however, that choices in set B have been subject to at least one decision at an earlier time, with the most recent time of decision denoted by t₀. Assume that choice bₘ was selected at this most recent decision and that the present worth of this choice b*ₘ(0,1) can be determined by an algorithm specified in the model.

Under these conditions, the appeal of each choice in set C can be updated before the first decision is made with an algorithm represented by the following function,

c̅ⱼ(1)=F_{A}(m,b*ₘ(0,1),c̅ⱼ∘bₘ,C:B, . . . ), j=1, . . . , N_{c}.

Here, F_{A} is an update function, like F_{D} in formula (E2), which depends on the variables listed explicitly and on additional parameters (the ellipsis) to be fully specified in an embodiment. For example, in a simple embodiment, the function F_{A} (“update by analogy”) could have the form,

F_{A}=g(C:B)·f(cⱼ∘bₘ)·F_{D}(m,b*ₘ(0,1), . . . ).

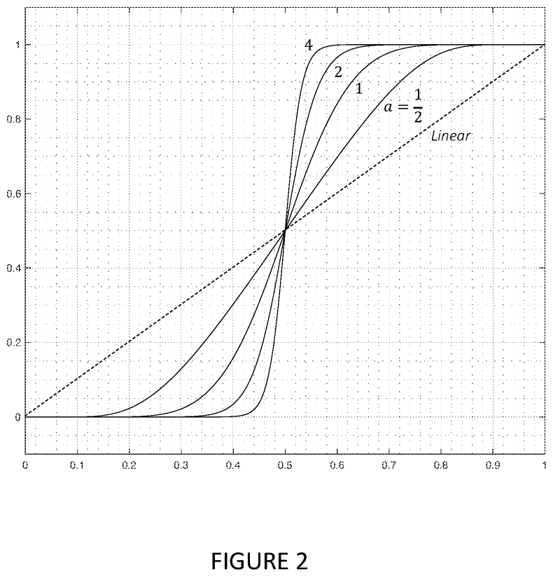

Here, f and g are scalar functions that modify linearly the update that would have occurred if choice m had been selected from set C in a decision made at time t₀. FIG. 2 shows possible forms for the functions f and g.

A general form of update by analogy, for a decision at any time tₖ, can be represented by the formula

c̅ⱼ(k)=F_{A}(m,k′,k,b*ₘ(k′,k),cⱼ∘bₘ,C:B, . . . ), j=1, . . . , N_{c}. (E4)

Here, for generality, k′ labels the time, earlier than tₖ, when a decision was made from set B and becomes, along with the current time index k, an explicit variable of F_{A}, since the “freshness” of the analogy is relevant to the update.

UPDATING BY PREDICTION. Observation of the outcome of past choices can be viewed as an indirect way of predicting the eventual worth of a selection from a candidate set. Predictions can also be made directly before a decision is made. In an embodiment of the model, let methods be specified for making a prediction (before a decision is made) of the eventual worth of choices in the candidate set if they were to be selected at the next decision. Let this predicted worth be denoted by Pc*ⱼ(k, k′), which is a (positive or negative) real number. For example, Pc*₃(1,2) would stand for the predicted worth of choice 3 at time t₂ if it were to be selected at time t₁. A simple example would be predicting the price of a stock one week into the future based on its past performance and the state of the market.

Predictions can be used to update the appeals of choice before a decision is made with an algorithm that can be represented by a formula like (E3),

c̅(k)=F_{P}(n,Pc*ₙ(k,k+1),α₁(k),α₂(k), . . . ,α_{L}(k)). (E5)

The function for updating by prediction, Fₚ, can be essentially the same as F_{D}, although a sophisticated embodiment would likely treat a predicted worth differently from an observed worth. Notice that the time values in the arguments for the predicted worth in the right-hand side of formula (E4) are now forward looking from the time value on the left-hand side, which is appropriate for prediction.

When using formula (E5) to update the appeal of choices, predictions do not have to be made for all choices in the candidate set. But, as with direct feedback, once a prediction is made for any choice, and its appeal is updated, the probability of selection changes for all choices in the candidate set.

UPDATING BY PREDICTION AND ANALOGY. Another method for updating the appeal of choices combines prediction with analogy. Consider an auxiliary set of choices B and let a prediction be made for the expected worth of one of its members, Pb*ₘ. This value can be used to update each of the choices in set C with an algorithm represented by a formula like (E3),

c̅ⱼ(k)=F(m,k′,k″Pb*ₘ(k′,k″),cⱼ∘bₘ,C:B, . . . ), j=1, . . . , N_{c}. (E6)

Here, k′ and k″ label the starting and ending times of the interval covering the prediction (for the worth of choice bₘ) and become explicit variables of the update function F.

An algorithm represented by formula (E6) can encompass all the update methods described so far through the following observations:
Sets C and B can be taken as the same sets of choices.
One way of predicting the future value of choices (as mentioned earlier) is by observation of the worth of past choices after their selection.

SYSTEM STATES. Decision-making takes place in a specific context, which includes the state of the system (its internal state) and the state of its environment (its external state). One further refinement of the model accounts for the context of decisions. For example, the selection of a stock to add to an investment portfolio can depend on the time of year and the state of the market (and the economy in general), as well as with the investor's age, wealth, income, and risk profile. To use context in decision-making, let the state of the system be represented by a collection of state variables at a given point in time,

S(k)={s₁(k), s₂(k), . . . , s_{N}_{ₛ}(k)}.

Here, S(k) represents the overall state of the system at time tₖ, and each state variable sᵢ(k) can be a number (temperature, date), a collection of numbers (a digital image), or a more general quantitative description (“risk aversion on a scale of 1 to 10”).

An embodiment of the model can specify a method for observing and recording system states as well as an algorithm for computing the resemblance of two system states,

R(S(k),S(l))∝S(k):S(l)→[0,1].

Both the current system state and its resemblance to a past state (or states) are natural parameters in the general update formula (E6). Writing this explicitly gives another representation of the algorithm for updating the appeal of choices before a decision,

c̅ⱼ(k)=F(m,k′,k″,Pb*ₘ(k′,k″),cⱼ∘bₘ,C:B,S(k),S(k):S(k′), . . . ), j=1, . . . , N_{c}. (E7)

In a simple embodiment of formula (E7), the dependence on the three resemblance parameters can be factored into the multilinear form,

c̅ⱼ(k)=h(S(k):S(k′))·g(C:B)·f(cⱼ∘bₘ)·F(m,k′,k″,Pb*ₘ(k′,k″), . . . ).

Here, h is a scalar function of the resemblance of two system states.

RESEMBLANCE FUNCTIONS. This section gives an explicit example of resemblance functions which could be used to compare choices, sets of choices, and system states in an embodiment of the model.

Let sets B and C be collections of images: C is the candidate set for a decision (“Choose the healthiest red rose”); B is the auxiliary set. Let each image, cₙ or bₘ, be represented as a P×Q array of non-negative real numbers (pixels), strung together row by row into a long vector,

cₙ=[c_{n,1}, c_{n,2}, . . . , c_{n,T}], T=P×Q,

bₘ=[b_{m,1}, b_{m,2}, . . . , b_{m,T}], T=P×Q.

A measure of the resemblance of any two images is the cross-correlation of their vectors,

$${c}_{n} ∘ {b}_{m} = \frac{{c}_{n} \cdot {b}_{m}}{{( {c}_{n} \cdot {c}_{n} )}^{1 / 2} {( {b}_{m} \cdot {b}_{m} )}^{1 / 2}} \to [ 0 , 1 ] .$$

Here, cₙ·bₘ=Σᵢc_{n,i}b_{m,i} is the standard inner product of two numerical vectors. If the sets have the same number N of images, and there is a natural ordering, so that image cⱼ is paired with image bⱼ, then an estimate of the overall resemblance of the sets is the normalized sum of cross-correlations,

$$C : B = \frac{1}{N} {\sum }_{j} {c}_{j} ∘ {b}_{j} \to [ 0 , 1 ] .$$

If there is no natural ordering, the sum of correlations can be taken over all image pairs, a construction that can also handle cases in which the sets have different numbers of elements,

$$C : B = \frac{1}{{N}_{c} {N}_{b}} {\sum }_{i} {\sum }_{j} {c}_{i} ∘ {b}_{j} .$$

A simple form for the functions of resemblances, (f, g, h), is a linear curve rising from 0 to 1 on the interval [0, 1] (the range of resemblances), as shown in FIG. 2. A more general form is an S-shaped curve on the interval [0,1], for example, the following warped version of the logistic function,

$$w ( x ) = \frac{1}{2} ( 1 + \frac{{e}^{ay ( x )} - {e}^{- ay ( x )}}{{e}^{ay ( x )} + {e}^{- ay ( x )}} ) , y ( x ) = - \frac{1}{x} + \frac{1}{1 - x} , 0 \leq x \leq 1.$$

Here, a is a parameter that controls the sharpness of the transition between w(0)=0 and w(1)=1. FIG. 2 also shows examples of w(x) for different values of a.

To summarize, this disclosure relates to a model of automated decision-making that uses random selection in the final step but also incorporates non-random processes—involving algorithms of feedback, analogy, and prediction—to modify selection probabilities over time and thereby improve the odds of making a good choice, while allowing the algorithm some freedom of choice (the random step). A full embodiment of the model requires
(a) Specification of algorithms for initializing the model
(b) Specification of algorithms for computing all quantities in the general formula (E7), or its more specialized versions, for updating the appeals of choices—and thus their probabilities computed with formula (E1)—before decisions are made by random selection
(c) Specification of the resemblance functions of choices and sets of choices, r and R, if analogy is used
(d) Specification of the state variables in system states and the resemblance function of system states if state variables are used
(e) Specification of how the worth of selected choices, including analogous choices, are evaluated at any given time
(f) Specification of how predictions for the worth of choices are made
(g) Specification of rules that govern the sequence of decisions, including how often analogy and prediction are used, when updates are evaluated, and the algorithm of random selection.

What is claimed is:

1. A method for making a sequence of decisions by random selection from a set of choices (candidate set), with the probability of selection of each choice determined by its appeal, a (real) number associated with each choice which can evolve over time.

2. The method of claim 1 in which algorithms are specified for evaluating the worth of a selected choices after a decision is made and using that value to update the appeal of the selected choice and, thereby, the selection probabilities of all choices in the next decision.

3. The method of claim 1 in which the mechanism for updating the appeal of choices before a selection is made involves evaluating the worth of a similar choice made earlier from an analogous set of choices and using that evaluated worth in an algorithm that updates the appeal of each choice in the candidate set based on its similarity with the analogous choice made earlier.

4. The method of claim 1 in which the mechanism for updating the appeal of choices before a selection is made involves predicting the worth of each choice, or a subset of choices, and using that predicted worth in an algorithm that updates the worth of each choice before the next decision is made.

5. The method of claim 1 in which the mechanism for updating the appeal of choices before a selection is made involves predicting the worths of choices from an auxiliary set which resembles the candidate set and using those prediction worths in an algorithm that updates the worth of each choice in the candidate set before the next decision is made.

6. The method of claims 1 to 5 in which the mechanism for updating the appeal of choices before a selection is made involves evaluating the worth of past choices made from an analogous set of choices and using those evaluated worths in an algorithm that compares quantitatively the system state at the current time, when a new decision is being made from the candidate set, with the system state at times when past selections were made and updates that information to appeals of choices from the candidate set before a next decision is made.
